(19) United States
(12) Patent Application Publication
(10) Pub. No.: US 2006/0154601 A1
(43) Pub. Date: Jul. 13, 2006

(54) Apparatus and method for providing automatically generated personalized web content for mobile users

(76) Inventors: Wayne R. Tewalt, Mukilteo, WA (US); Richard A. Novak, Langley, WA (US); Charles K. Claxton, Seattle, WA (US)

Correspondence Address: HARNESS, DICKEY & PIERCE, P.L.C., P.O. BOX 828, BLOOMFIELD HILLS, MI, 48303, US

(21) Appl. No.: 11/035,332

(22) Filed: Jan. 13, 2005

(51) Int. Cl. H04B 7/185

(52) U.S. Cl. 455/12.1

(57) ABSTRACT

A system is provided for creating a personalized user interface on a mobile platform to deliver personalized information content to a personal electronic device (PED) of a user on-board the mobile platform. The system includes at least one portal operable to communicate with the user's PED and a first database operable to maintain a set of characteristics relating to the user, the mobile platform and/or other factors. A controller is in communication with the database, and the controller transmits to the PED of the user information content received from a second database of a central control station. The information content is provided in accordance with the characteristics stored in the first database, and thus forms personalized information content and advertisements for the user.

### FIELD OF THE INVENTION

The present invention relates to mobile communications systems and particularly to automatically generated personalized Web content for users on-board a mobile platform.

### BACKGROUND OF THE INVENTION

Broadband data and video services, on which our society and economy have grown to depend, have generally not been readily available to users on-board mobile network platforms such as aircraft, ships, trains, automobiles, etc. While the technology exists to deliver such services to most forms of mobile network platforms, past solutions have been generally quite expensive, with low data rates and/or available to only very limited markets of government/military users and some high-end maritime markets (i.e., cruise ships).

Many previously developed systems which have attempted to provide data and video services to mobile network platforms have done so with only limited success. One major obstacle has been the high cost of access to such broadband data and video services. Another problem is the limited capacity of previously developed systems, which is insufficient for mobile network platforms carrying dozens, or even hundreds, of passengers who each may be simultaneously requesting different channels of programming or different data services. Furthermore, presently existing systems are generally not readily scalable to address the demands of the traveling public.

Of particular interest, many presently existing systems also have not comprehensively addressed user interfaces for a mobile network platform. As broadband data and video services become more widespread among the various mobile platforms, interfaces will have to be developed to serve these users. Existing Web sites target Internet users who are fixed in one location during use. Mobile platforms with Internet service provide unique opportunities and challenges for relating Web content with the user experience. Thus, it is desirable to increase the service usage rate by providing relevant content such as destination information, in-flight messages, and personalized advertisements. Accordingly, it would be desirable to provide an automatically generated personal Web content interface for users on-board a mobile platform.

### SUMMARY OF THE INVENTION

The present invention provides a system for creating a personalized user interface on a mobile platform. The system includes at least one user interface operable to communicate with a user on-board a mobile platform and a first database operable to maintain a set of characteristics. A controller is in communication with the first database, and the controller is operable to transmit to the at least one user interface personalized information content based on the set of characteristics accessed from the first database.

In one preferred implementation a central control station remote from the mobile platform is used to provide stored information content from a second database associated with the central control station. The stored information content is supplied from the second database in accordance with the characteristics stored in the first database.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a schematic depicting a mobile network system on a mobile platform utilizing the automatically generated personalized Web content user interface according to one preferred embodiment of the present invention;

FIG. 2 is a detailed schematic of the mobile network system of FIG. 1; and

FIG. 3 is a flow chart illustrating the steps performed by the mobile communications system of FIG. 2.

### DETAILED DESCRIPTION OF THE PREFERRED EMBODIMENTS

The following description of various embodiments is merely exemplary in nature and is in no way intended to limit the invention, its application, or uses. Although the following description is related generally to a system for automatically providing personalized content to mobile users, it will be understood that the principles of the present invention are applicable to a variety of other users in various settings. Therefore, it will be understood that the following discussion is not intended to limit the scope of the appended claims.

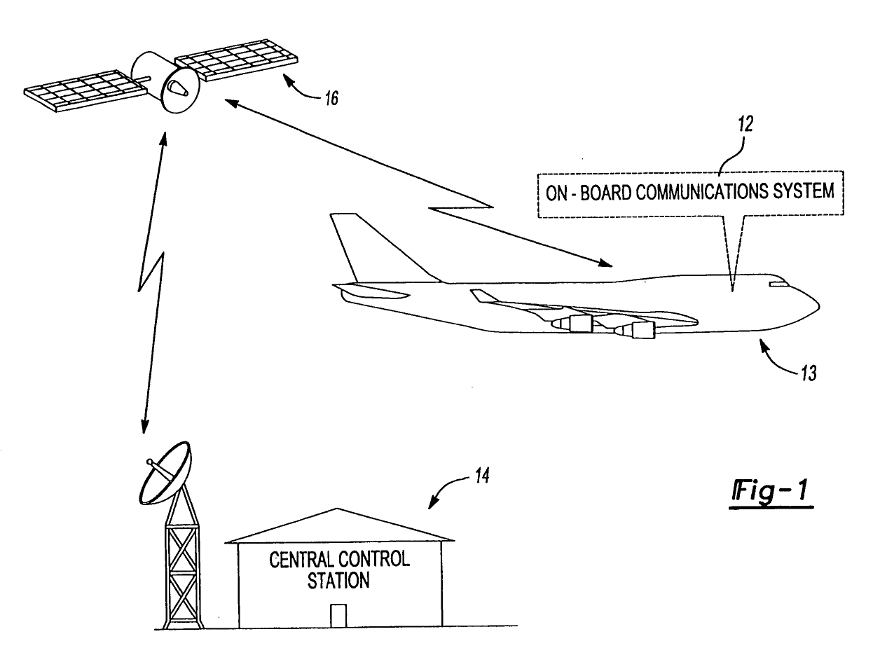

With reference to FIG. 1, a preferred embodiment of a system for automatically generating personalized information content 10 is illustrated. The mobile network system 10 includes a communication subsystem 12 carried on-board a mobile platform 13, and a central control station 14. The mobile platform 13 may be any type of propelled platform adapted to transport at least one user, such as an aircraft, motorcraft, ship, train, bus or other platform. The mobile platform 13 is in communication with the central control station 14 via at least one transponded satellite 16.

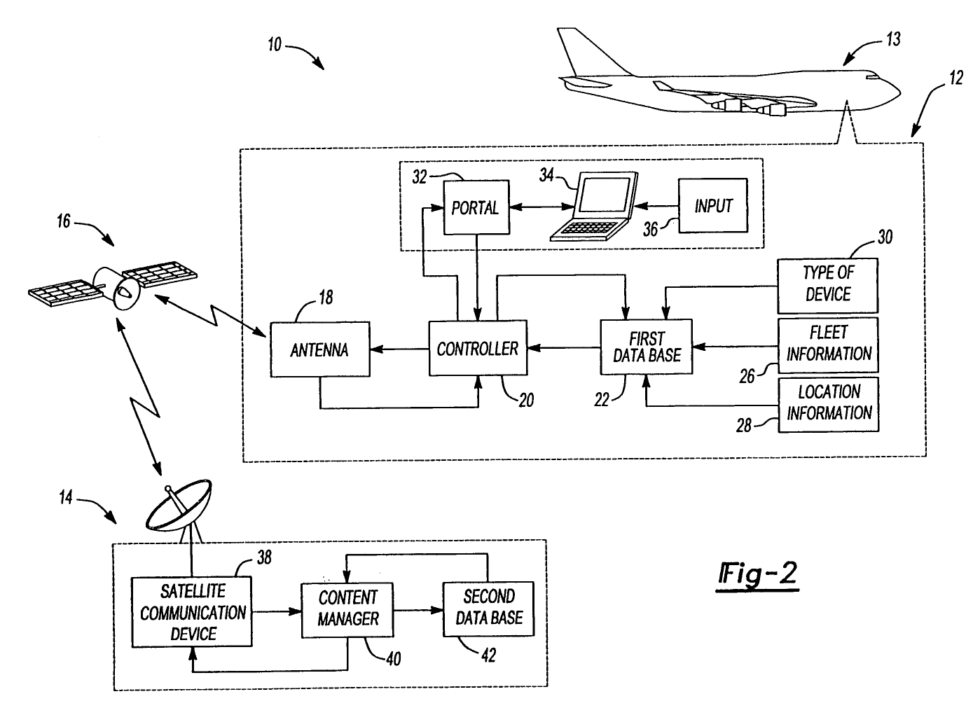

With continuing reference to FIG. 1 and additional reference to FIG. 2, the communications subsystem 12 includes an antenna 18 in communication with the satellite 16. The antenna 18 may comprise a conventional phased array antenna, a mechanically scanned phased array antenna or a conventional, mechanically scanned reflector antenna. The antenna 18 is preferably mounted on an exterior surface of the fuselage of the mobile platform 13, if the platform is an aircraft, and covered with a radome. Various suitable antennas are described in U.S. Pat. Nos. 6,670,930, 6,714,163, 6,633,266, 6,717,552, 6,661,388 and 6,483,474, all owned by the Boeing Company, and all incorporated by reference into the present application. The antenna 18 is further in two-way communication with a controller 20. The controller 20 receives information from the antenna 18 from a first database 22, and from a user interface system 24.

The first database 22 is in bidirectional communication with the controller 20. The first database 22 is generally configured to receive various characteristics associated with the mobile platform 13, such as fleet information 26, user location information 28, and a device type 30 each of which may be collected automatically when the user accesses the service to facilitate the creation of a user demographic profile. The fleet information 26 may include the departure location, destination location, real-time navigation information, anticipated route of travel, tail number of the mobile platform or other identification information associated with the mobile platform, such as operator identification. The user location information 28 may be the physical location of a user in a cabin of the mobile platform 13, such as a row number, seat number, or cabin class. The device type 30 may be information associated with the kind of user interface system 24 used to access the mobile network system 10, such as the manufacturer name, model, or type of network connection, as will be discussed in greater detail below. The first database 22 may also be configured to store information associated with a user, such as user preferences, including desired Web content or URL addresses.

The user interface system 24 is in communication with the controller 20 to send and receive data over the mobile network system 10. More specifically, the user interface system 24 includes a portal 32 and a user interface device or a user personal electronic device (PED) 34, able to receive a user input 36 from a user. The portal 32 enables the PED 34 to communicate with the controller 20. The portal 32 may be a hard wired connection able to couple to a network cable. Alternatively, it may comprise a wireless connection or a connection furnished through an entertainment system of the mobile platform 13. Thus, the PED 34 may be any type of interfacing means capable of connecting to the wired or wireless connection associated with the portal 32, or it may comprise the entertainment system of the mobile platform 13.

The PED 34 may include laptops, personal digital assistants, smart phones, cell phones, handheld computers or any other device capable of displaying Web-based information and/or communicating data. The PED 34 enables the user to communicate through the user input 36 requests for desired Web content, personal preferences and the login information required to access the mobile network, as will be described in greater detail below. The input 36 from the user is processed by the controller 20 and a content request is transmitted through the antenna 18 to the satellite 16. The satellite 16 in turn relays the request to the central control station 14.

The central control station 14 includes a satellite communication device 38 in communication with a content manager 40. The content manager 40 is in communication with a second database 42. The satellite communication device 38 may comprise an antenna system and suitable transceiver for communicating with the satellite 16. The satellite communication device 38 receives the signal from the antenna 18 of the mobile platform 13 and transmits this signal to the content manager 40.

The content manager 40 preferably includes a controller. The content manager 40 analyzes the received data and performs operations based on that data, such as storing the data in the second database 42 or selecting stored content from the second database 42 which may be transmitted back to the mobile platform 13.

The second database 42 is in communication with the content manager 40 and may be configured to store data received from the content manager 40 as it is received. Additionally, the second database 42 may be configured with stored Web-page content, such as e-commerce sites, advertising, and destination specific information detailing, for example, available shopping, dining, hotels, and points of interest. Further, the content stored in the second database 42 may be stored in languages other than English to enable foreign language speaking users to be provided with content in their native language. This would enable all travelers, not just English speaking travelers, to research their destination location. Alternatively, this information could be stored on the first database 22 on the mobile platform 13. The second database 42 may also store information related to previous users of the mobile network system 10. This information may include content preferences, language preferences, e-commerce preferences and other similar information.

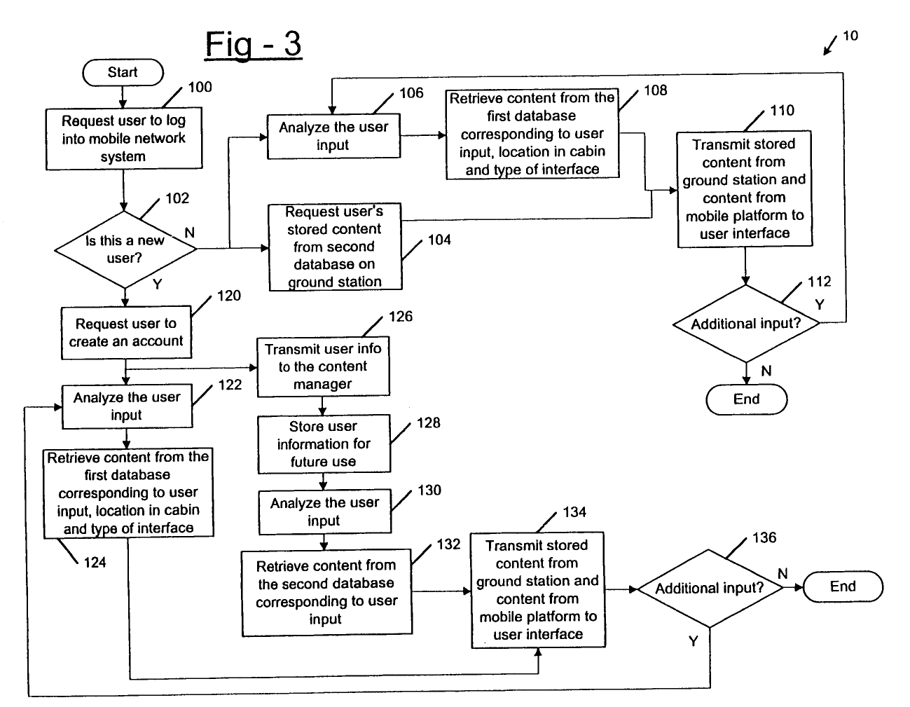

Once a user boards the mobile platform 13, he/she may couple their PED 34 to the mobile network system 10 by using the portal 32. Referring to FIG. 3, upon connecting to the portal 32, the controller 20 will send the user a message asking the user to log in to the mobile network system 10, as indicated at operation 100. Based on the input from the user, at operation 102, the controller 20 will determine if the user is a new user or a previous user. If the user is a previous user, at operation 104 the controller 20 accesses the second database 42 by transmitting a request via the antenna 18 to obtain the user's stored content from the second database 42.

Simultaneously, at operation 106, the controller 20 analyzes the user input 36 and then at operation 108, the controller 20 accesses the first database 22 to obtain content based on the fleet information 26, user location information 28 and device type 30. At operation 110, the controller 20 transmits both the stored content from the second database 42 and the content from the first database 22 to the PED 34 which may then display the stored content from the second database 42 and content from the first database 22 to the user. Next, the user may interact with the content displayed on the Web-page, and at operation 112, the controller 20 checks for an additional input 36 from the user. Based on any additional input 36 from the user, the controller 20 their repeats operation 106.

If the user is a new user, in operation 120, the controller 20 asks the user to create an account. Generally the user is asked to enter personal data such as mailing address, age, credit card information, preferred language, etc. Other personal preferences, such as desired Web content, i.e. news, sports, movies, music and the like, can also be requested by the controller 20. At operation 122, the controller 20 analyzes the information provided by the user to create the account. At operation 124, the controller 20 selects data from the first database 22 that corresponds to the information provided by the user, such as news or sports related to the user's geographic area, advertisements targeting the user's age or other e-commerce links which match that user's demographics. In addition, at operation 124, the controller 20 will select additional content based upon the user location information 28 and device type 30 of the PED 34.

As operations 122 and 124 are being performed, the controller 20, at operation 126, transmits the information used to set up the user's account to the content manager 40 at the central control station 14. At operation 128, the content manager 40 stores the information used to set up the user account. Then, at operation 130, the content manager 40 analyzes the information used to set up the user account and selects stored content from the second database 42 that corresponds to the information entered to open/initialize the user account. Next, at operation 132, the content manager 40 transmits the stored content to the mobile platform 13.

The controller 20, once receiving the stored content from the content manager 40, then transmits both the stored content and the content from the first database 22 to the PED 34 for display at operation 134. Next, the user may interact with the content displayed on the Web-page, and at operation 136, the controller 20 checks for additional input from the user. Based on any additional input from the user, the controller 20 may decide to access additional content from the first database 22 or the second database 42. Thus, the first database 22 combines the user input data with the mobile platform data such as direction and location to create a unique user demographic profile.

The preferred embodiments enable a user accessing a mobile network to interact with Web content which is automatically tailored to their needs. The Web content may be generated from the first database 22 located on the mobile platform 13 and may include stored content from the second database 42 which is located external to the mobile platform 13 at the central control station 14. The personalized Web content may not only provide the user with information specific to the mobile platform 13 and the destination to which they are approaching, but it may provide that information in a form that is most easily understood by that mobile user, i.e. in his/her native language. This enables mobile users to quickly and easily interact with the Web content and also improves the efficiency of the user's interaction with the mobile network, as significant amounts of the content will be directly related to user preferences and user demographics.

Further, the dynamic Web content allows for placement of Web based advertisements tailored to the specific flight or destination and the preferences and demographics associated with the user. This increases the response rate to such advertisements as the content of the advertisements is directly related to the user and their travel experience. In addition, navigation and destination content may encompass more than merely travel information. Rather, it may include location specific messages and other content to the user during his/her time on-board the mobile platform 13, such as location specific messages including warnings to the user that the service is about to be interrupted or content related to regions being traversed traveling on the mobile platform 13.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. A system for creating a personalized user interface on a mobile platform for a user operating a personal electronic device (PED), the system comprising:
at least one user interface operable to communicate with the user's PED on-board a mobile platform;
a database operable to maintain a set of characteristics unique to the user; and
a controller in communication with the database, the controller operable to transmit to the at least one user interface personalized information content based on the set of characteristics stored in the database.

2. The system of claim 1, further comprising at least one portal operable to enable the user interface to communicate with the controller, wherein the at least one portal is selected from the group comprising at least one of: a wireless access system, a network cable, and an in-flight entertainment system.

3. The system of claim 2, wherein the user interface is selected from the group comprising at least one of: cellular phones, personal data assistants, laptop computers, handheld computers, and in-flight entertainment systems.

4. The system of claim 2, wherein the characteristics maintained by the database includes data selected from the group comprising at least one of: airline data, departure information, destination information, user demographics, a user created profile, type of user access device, and the user's location within the mobile platform.

5. The system of claim 1, wherein the controller is in communication with a ground system, the ground system comprising:
a content management system operable to communicate with the controller of the mobile platform;
a database in communication with the content management system, the database operable to receive data entered by the user into the user interface; and
wherein based on the data entered by the user into the user interface, the content management system receives stored content from the database and transmits the stored content from the database to the controller of the mobile platform.

6. The system of claim 5, wherein the content management system communicates with the controller on-board the mobile platform via at least one transponded satellite.

7. The system of claim 6, wherein the mobile platform further comprises at least one antenna in communication with the controller on-board the mobile platform, the antenna operable to communicate with the transponded satellite.

8. The system of claim 5, wherein the controller of the mobile platform transmits the stored content from the database of the ground system with the personalized content from the database of the mobile platform to create the personalized user interface.

9. A mobile network system operable to connect a personal electronic device (PED) of a user to a mobile communications system on-board a mobile platform, the mobile network system comprising:
at least one user interface operable to communicate with the PED of the user on-board the mobile platform;
a controller coupled to the user interface, the controller operable to communicate with the user interface to receive information from the PED;
a first database accessible by the controller, the first database operable to interface with the controller to provide the controller with a first information content based at least on information received from the user interface;
a second database in communication with the controller, the second database being located remote from the mobile platform and operable to provide the controller with a second quantity of information content; and
wherein the controller transmits the first information content and the second information content to the user interface for use on the PED of the user.

10. The mobile network system of claim 9, further comprising at least one portal operable to enable the user interface to communicate with the controller, wherein the at least one portal is selected from the group comprising at least one of: a wireless access system, a network cable, and an in-flight entertainment system, or combinations thereof.

11. The mobile network system of claim 10, wherein the user interface is selected from the group comprising at least one of: cellular phones, personal digital assistants, laptop computers, handheld computers, and in-flight entertainment systems.

12. The mobile network system of claim 10, wherein the first database provides the first content based on data selected from the group comprising at least one of: airline data, departure information, destination information, user demographics, data from the user interface, type of user access device, and location in the cabin of the mobile platform.

13. The mobile network system of claim 12, wherein the second database is in communication with a ground system, the ground system comprising:
a content management system operable to communicate with the controller on-board the mobile platform, and being in communication with the second database; and
wherein based on the information entered by the user into the user interface, the content management system receives stored content from the second database and transmits the stored content from the second database to the controller on-board the mobile platform.

14. The mobile network system of claim 13, wherein the content management system communicates with the controller of the mobile platform via at least one satellite.

15. The mobile network system of claim 14, wherein the mobile platform further comprises at least one antenna in communication with the controller of the mobile platform, the antenna operable to communicate with the satellite.

16. A method for creating a personalized user interface for communicating with a personal electronic device (PED) of a user, the method comprising:
transmitting a request to a mobile network from the PED of the user on a mobile platform;
selecting a first personalized information content from a first database on a mobile platform based on the request from the user the first personalized content relating to a characteristic associated with one of the mobile platform and the user;
selecting a second personalized information content from a second database external to the mobile platform; and
transmitting the first personalized content to the mobile network in accordance with the characteristic obtained from the first database and second personalized content through the mobile network to the user.

17. The method of claim 16, further comprising:
inputting characteristics into the database on the mobile platform, the characteristics selected from at least one of: airline data, departure information, destination information, user demographics, data from the user interface, type of user access device, and location in the cabin of the mobile platform.

18. The method of claim 16, further comprising:
connecting the user to the mobile network by a user interface wherein the user interface is in communication with the mobile network through at least one of: a wireless access system, a network cable, and an in-flight entertainment system.

19. The method of claim 16, wherein the step of selecting a second personalized content from a database external to the mobile platform further comprises:
transmitting the request from the mobile platform to a satellite;
receiving the request from the satellite at a ground station;
analyzing the request; and
transmitting the selected second personalized content from the ground station to the satellite.

20. The method of claim 19, further comprising:
storing the request in the second database.
